(19) United States
(12) Patent Application Publication
(10) Pub. No.: US 2006/0202365 A1
(43) Pub. Date: Sep. 14, 2006

(54) Self contained wall mounted room humidifier

(76) Inventor: Larry Allen Cluchey, Grandville, MI (US)

Correspondence Address: Larry Cluchey, 4509 Penny Lane, SW, Grandville, MI, 49418, US

(21) Appl. No.: 11/363,289

(22) Filed: Feb. 27, 2006

Related U.S. Application Data
(60) Provisional application No. 60/659,668, filed on Mar. 8, 2005.

(51) Int. Cl. B01F 3/04

(52) U.S. Cl. 261/117; 261/DIG. 65

(57) ABSTRACT

A mist generating, self contained wall mounted room air humidifier ensures substantially complete evaporation of the mist introduced to an air flow drawn from a room environment by preferably providing a bypass air stream of un-humidified room air to cause complete and immediate evaporation.

The invention relates to self-contained room air humidifiers. More particularly, the invention relates to mist generating room air humidifiers of the wall mount configuration as described in provisional patent application No. 60/659,668 filing date Mar. 08, 2005.

### BACKGROUND OF THE INVENTION

Self-contained room air humidifiers are used to introduce water, and other additives, to air in an enclosed environment, such as a room. Mist generators or mist sources, such as steam boilers, atomizers, nebuliziers and ultrasonic vibrators have been used to present water in the form of droplets to a passing air flow.

Self-contained room air humidifiers are typically constructed in compact housings. Also, self-contained room air humidifiers in the past have injected the mist of water particles into the room environment for subsequent evaporation. Many droplets produced by the mist generator and introduced to the room environment to be humidified do not completely evaporate before contacting and wetting objects in the room or the room structure. Other configurations of the existing art utilize integral evaporation chambers to give the moisture time to be absorbed before discharge into the room environment. This configuration typically works best at lower relative humidity levels. At higher levels of room humidity, the mist is not completely evaporated in the absorption chamber and will be visible on the discharge of the room humidifier. Additional variations of this type of existing art add electric heaters to warm the air stream to enhance evaporation. The additional energy required by the electric heaters greatly off set any advantage gained from using a non-steam mist generator. In addition, this configuration requires floor space, which is extremely valuable in commercial and industrial environments.

### SUMMARY OF THE INVENTION

It is an object of the invention to provide a self-contained wall mounted room air humidifier that prevents moisture fall out in the humidified room by mixing the discharged humidified air with dry un-humidified room air.

It is a further object of the invention to provide a self-contained room air humidifier that is constructed for wall mounting to minimize required floor space for the self-contained room air humidifier.

It is yet another object of the invention to provide a self-contained wall mounted room air humidifier that can be positioned in a variety of room locations including against a wall to avoid obstruction to intended room activity with out exposing the wall or other room structure to moisture damage.

It is still another object of the invention to provide variable levels of humidification without exposing room objects to moisture damage.

These and other objects of the invention are achieved by preferred embodiments of a self-contained wall mounted room air humidifier that receives air from the room environment and mixes the humidified discharge air with an un-humidified bypass air stream drawn from the room environment to cause complete evaporation of the mist before impinging on room objects or room structure.

The self-contained wall mounted room air humidifier includes a housing having an inlet for receiving air from the room environment and an outlet for discharging humidified air back into the room environment. A mist generator is disposed in said housing for producing a mist to humidify the air received through the inlet from the room environment. A fan, or multiple fans, moves air past the mist generator and also provides the bypass mixing air.

According to a preferred embodiment of the invention, the housing of the self-contained wall mounted room air humidifier has a drain connection for disposing of excess water that may be generated by the mist generator, but not discharged into the room environment.

In the preferred embodiment of the invention, the housing is constructed of stainless steel to prevent corrosion and enhance the appearance of the self-contained wall mounted room air humidifier.

The self-contained wall mounted room air humidifier includes controls to start and stop the fan(s), operate sump pumps if needed, and interface with the primary room environment humidity control system.

The preferred embodiment of the invention has a mixing chamber within the housing where the inlet air provided by the fan(s) is mixed with the mist provided by the mist generator. This mixing enhances the evaporation of the mist into the air drawn from the room environment by the fan(s). The air and mist are mixed using a counter flow arrangement, which causes turbulence and increased contact of the air and water mist. The humidified discharge air is mixed with the un-humidified bypass air external to the humidifier housing. The un-humidified bypass air is discharged below the humidified air and provides a horizontal layer of dry room air that mixes with and carries the humidified air into the room until it is completely evaporated.

### DETAILED DESCRIPTION OF PREFERRED EMBODIMENTS

The invention is directed to a self-contained wall mounted room air humidifier that provides for complete evaporation of the water mist within the room environment. The preferred embodiments of the invention discussed in this specification are arranged to minimize the area required by the self-contained wall mounted room air humidifier, while at the same time providing protection from water damage to the room contents.

The room environment, as used through out this specification and the claims, refers to the area to be humidified by the self-contained wall mounted room air humidifier. This area can include office and computer space, lab areas and industrial processing areas, and does not have to be completely enclosed from other areas of the structure.

The self-contained wall mounted room air humidifier is designed to be used primarily with water, and further water that has been purified using reverse osmosis or de-ionizing equipment. The purification of the water is important because this process reduces the concentration of the dissolved minerals in the water to a point where the evaporation of the water will not leave any mineral residue in the space that is humidified.

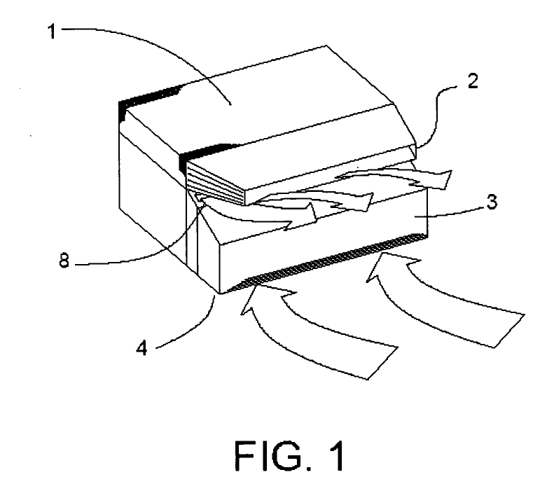

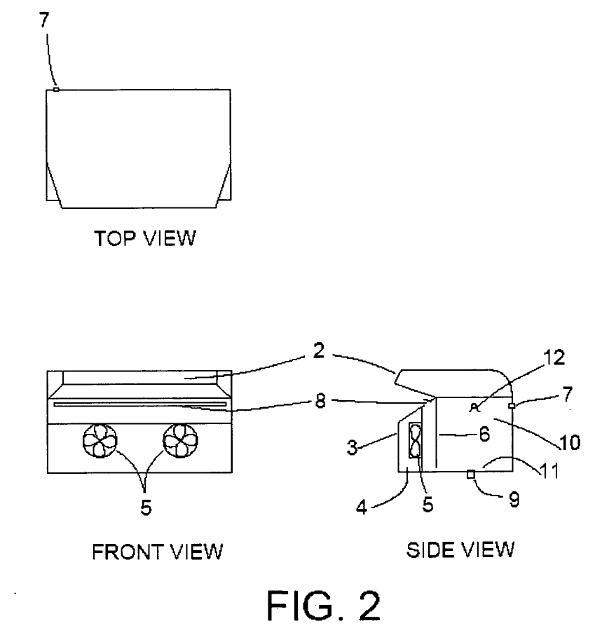

Referring to FIGS. 1 & 2, a preferred self-contained wall mounted room air humidifier includes a housing 1 having an inlet 4 for receiving air from the room environment and passing the air flow through a mixing chamber 10, for complete mixing of the mist and room air before discharge through an outlet 2 back into the room environment. The room air is drawn into the humidifier housing inlet 4 by the fan(s) 5. The room air is divided into two air streams by the internal baffle 6. Some of the air flows out of the by-pass air slot 8 to mix with the humidified room air discharged from the discharge opening 2. The remainder of the air passes into the mixing chamber 10 where it is mixed with the mist. The internal baffle 6 allows just enough air into the mixing chamber 10 to carry the moisture out of the humidifier into the room environment from the humidifier outlet 2. The mist is moving in a downward direction and the air passing under the internal baffle 6 is moving in an upward direction. The counter flow enhances the mixing of the air and mist and serves as a centrifugal separator because the larger water droplets in the mist cannot reverse direction and subsequently fall into the humidifier sump 11 to be drained away by the drain connection 9.

The mist source 12 is provided within the housing 1. The self-contained wall mounted room air humidifier 1 can include any of a variety of mist generators or mist sources. While the preferred embodiment disclosed utilizes one or more high pressure atomizing nozzles 12 for atomizing the water, the self-contained wall mounted room air humidifier can use other mist generators, such as steam generators, ultrasonic nebulizers or air/water atomizers.

What is claimed is:

1. A self-contained wall mounted room air humidifier that humidifies air drawn from a room environment and causes complete evaporation of the water mist as it is discharged back into the room, said self-contained wall mounted room air humidifier comprising:
a) a housing having an inlet for receiving air from the room and an outlet for discharging the humidified air back into the room, with integral sump for collecting excess water; and
b) a mist generator disposed in the housing for producing a water mist to humidify the air received through the inlet from the room environment; and
c) a mixing chamber that comprises an air stream that is counter flow to the mist generated to enhance the mixing and evaporation of the mist; and
d) a fan, or fans, enclosed in the housing, for moving the air into the mixing chamber, and for providing the by-pass air stream for mixing with the humidified air discharged through the discharge opening, said fans to have provisions for mounting inlet air filters; and
e) said humidifier shall have a by-pass air system to mix un-humidified room air with the humidified discharge air; and
f) said humidifier shall have means of adjustment to control the direction and volume of the by-pass air stream; and
g) the fans shall have provisions to control speed and on/off operation; and
h) the mist generator shall have means to control the amount of mist generated and shall interface with the room humidity control system.

2. The self-contained wall mounted room air humidifier according to claim 1, wherein the housing contains an ultra violet light source to eliminate any residual bacterial contamination that might be present in the water mist.
